(19) United States
(12) Patent Application Publication
(10) Pub. No.: US 2017/0368698 A1
(43) Pub. Date: Dec. 28, 2017

(54) FILM CUTTER

(71) Applicant: Yu-Chun HUANG, TAICHUNG CITY (TW)

(72) Inventor: Yu-Chun HUANG, TAICHUNG CITY (TW)

(21) Appl. No.: 15/483,362

(22) Filed: Apr. 10, 2017

(30) Foreign Application Priority Data
Jun. 23, 2016 (TW) 105209467

(51) Int. Cl. B26B 1/02; B26B 29/02

(52) U.S. Cl. CPC B26B 1/02; B26B 29/02

(57) ABSTRACT

A film cutter includes: a body unit having a gripping portion, a receiving portion, pivotal portion, a sliding portion, an access slit, and a film feeding opening; a movable knife having a pivotal connection portion pivotally disposed at the pivotal portion, and a cutting portion; an operating unit having a sliding portion disposed at the sliding portion of the body unit, an operating portion for driving the sliding portion, a knife controlling portion for actuating the movable knife to rotate about the pivotal portion and thus allow the cutting portion to be exposed from or to retract into the access slit; two blades disposed in the body unit and each having a sharp edge tilted at an angle relative to and corresponding in position to the film feeding opening; and a guide member mounted on the body unit and corresponding in position to the film feeding opening.

### BACKGROUND OF THE INVENTION

### 1. Field of the Invention

The present invention relates to cutting tools and, more particularly, to a film cutter.

### 2. Description of the Prior Art

A conventional film cutter has a cutting portion that is protruded invariably to cut a tape. Another conventional film cutter has a cutting portion that is protruded and retracted flexibly but inconveniently, and/or actuated slowly, and/or secured unsteadily and imprecisely.

Therefore, the aforesaid drawbacks of the conventional film cutters still have room for improvement.

### SUMMARY OF THE INVENTION

In view of the aforesaid drawbacks of the prior art, it is an objective of the present invention to provide a film cutter with a movable knife which is not only protruded and retracted conveniently, quickly but also secured in place firmly, precisely.

In order to achieve the above and other objectives, the present invention provides a film cutter which comprises: a body unit having a gripping portion, a receiving portion, a pivotal portion, a sliding portion, an access slit, and a film feeding opening; a movable knife having a pivotal connection portion pivotally disposed at the pivotal portion of the body unit, and a cutting portion; an operating unit having a sliding portion disposed at the sliding portion of the body unit, an operating portion for driving the sliding portion, a knife controlling portion for actuating the movable knife to rotate about the pivotal portion of the body unit and thus allow the cutting portion of the movable knife to be exposed from or to retract into the access slit; two blades disposed in the body unit and each having a sharp edge tilted at an angle relative to and corresponding in position to the film feeding opening; and a guide member mounted on the body unit and corresponding in position to the film feeding opening.

Hence, the film cutter of the present invention is characterized in that the movable knife is not only protruded and retracted conveniently, quickly but also operated and changed conveniently due to the pivotal swing-related relationship between the operating unit and the body member.

Preferably, the body unit has an operating hole and an operating-positioning portion formed at the operating hole, and the operating portion is slidable within the operating hole and blocked by the operating-positioning portion from two sides.

Preferably, the body unit has two sliding-positioning portions, and the operating unit has a positioning portion positioned at each said sliding-positioning portion of the body unit.

Preferably, the operating unit has a slide and a cushioning element coupled to the slide, and the knife controlling portion is disposed at the cushioning element.

Preferably, the slide has an engaging-protruding portion, and the cushioning element has an engaging hole for fitting around the engaging-protruding portion of the slide.

Preferably, the movable knife has a first pressing-swinging portion actuated by the knife controlling portion to allow the cutting portion of the movable knife to retract into the access slit, and a second pressing-swinging portion actuated by the knife controlling portion to swing and thus allow the cutting portion of the movable knife to be exposed from the access slit.

Fine structures and features of the film cutter provided by the present invention are described in detail later. However, persons skilled in the art must understand that specific embodiments described below and carried out to implement the present invention are illustrative of the present invention rather than restrictive of the claims of the present invention.

### BRIEF DESCRIPTION OF THE DRAWINGS

FIG. 1 is a perspective view of a film cutter according to a preferred embodiment of the present invention;

FIG. 2 is an exploded view of the film cutter according to the preferred embodiment of the present invention;

FIG. 3 is another exploded view of the film cutter according to the preferred embodiment of the present invention;

FIG. 4 is a cutaway view of the film cutter according to the preferred embodiment of the present invention;

FIG. 5 is a cutaway view of the film cutter operating in a mode according to the preferred embodiment of the present invention; and

FIG. 6 is a cutaway view of the film cutter operating in another mode according to the preferred embodiment of the present invention.

### DETAILED DESCRIPTION OF THE EMBODIMENT OF THE INVENTION

Directional prepositions, such as “on” and “within,” used herein must be interpreted with reference to directions indicated in the diagrams of the present invention.

Technical solutions and features of the present invention are hereunder illustrated by embodiments and accompanying drawings and described in detail.

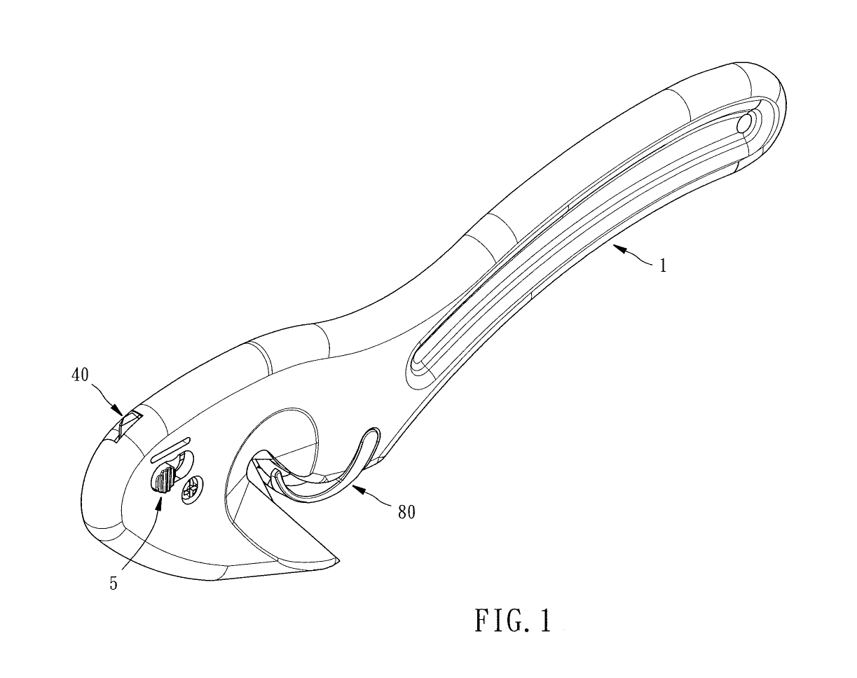

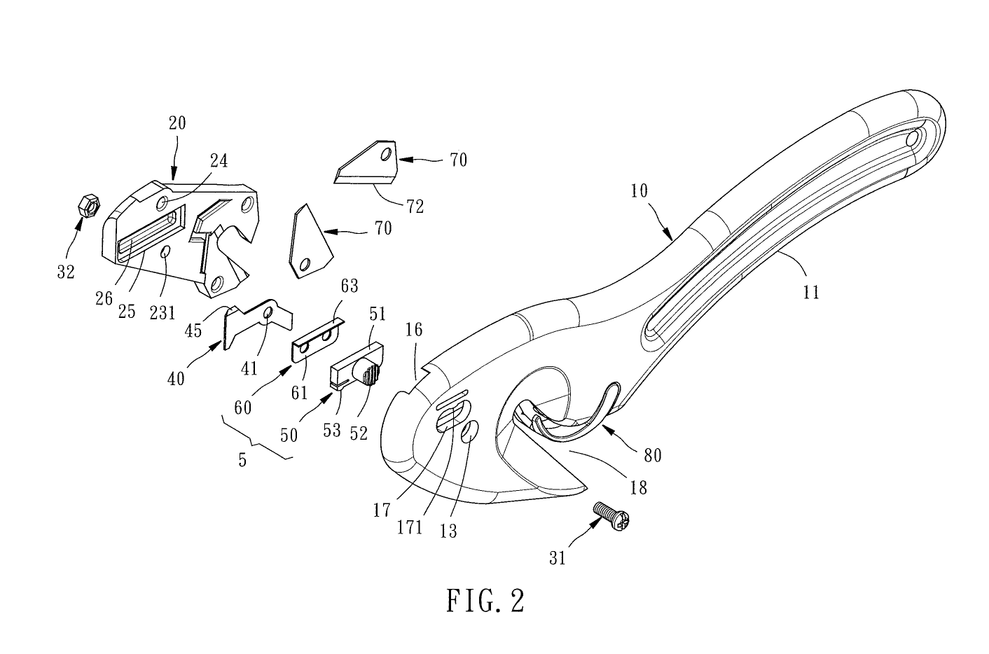

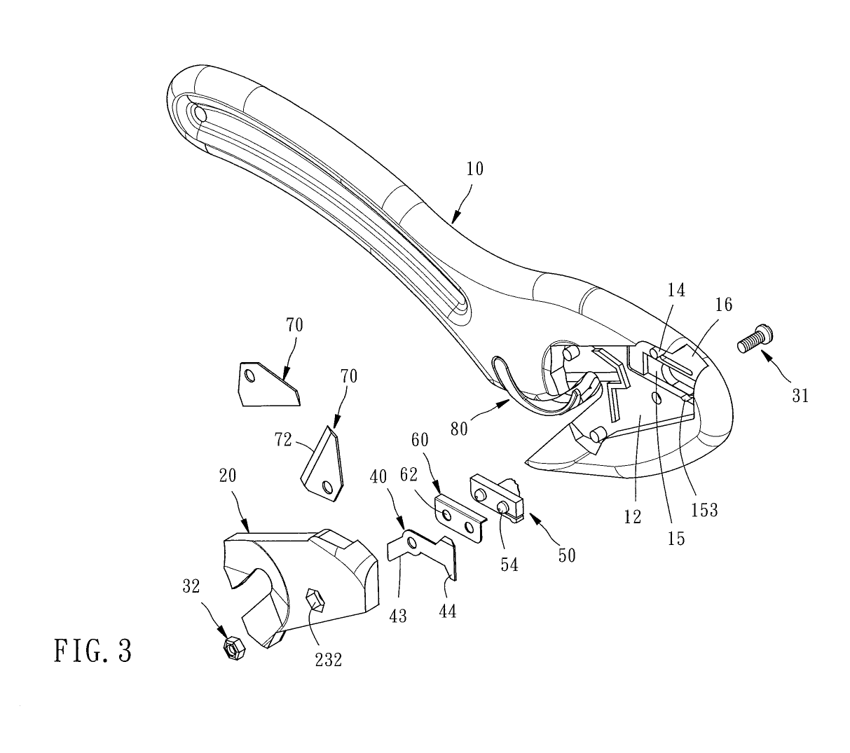

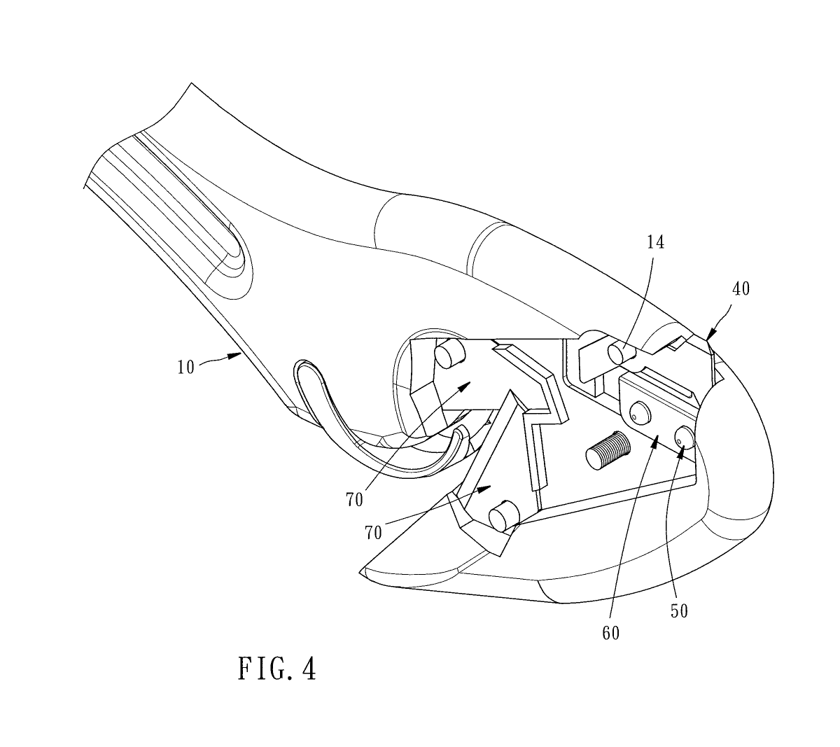

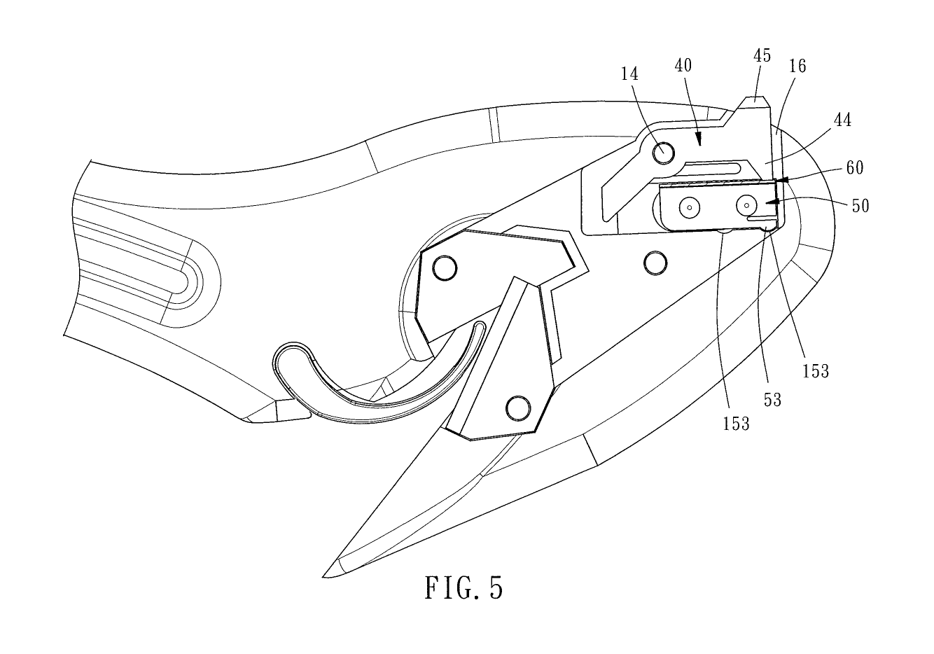

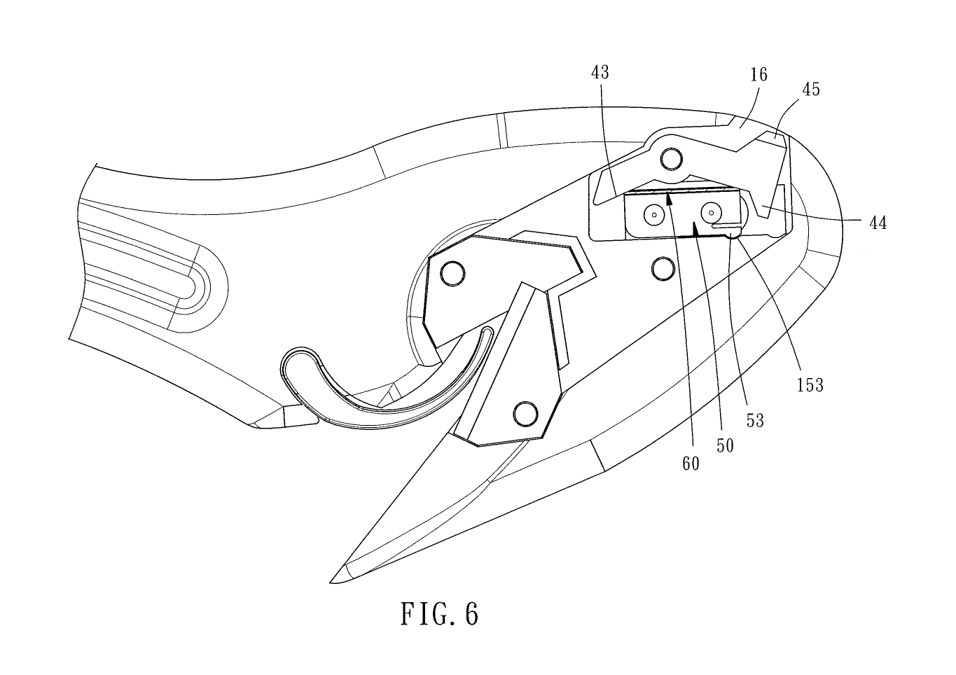

Referring to FIG. 1 through FIG. 6, a film cutter according to a preferred embodiment of the present invention comprises a body unit 1, a movable knife 40, an operating unit 5, two blades 70, and a guide member 80.

The body unit 1 has a body member 10 and a cover member 20 coupled to the body member 10 by a bolt 31 and a nut 32.

The body member 10 has a gripping portion 11, a receiving portion 12, a fastening hole 13 which the bolt 31 penetrates, a pivotal portion 14, a sliding portion 15, two sliding-positioning portions 153, an access slit 16, an operating hole 17, an operating-positioning portion 171 formed at the operating hole 17, and a film feeding opening 18.

The cover member 20 has a through hole 231 which the bolt 31 penetrates, a nut hole 232 for holding the nut 32, a pivotal hole 24 which the pivotal portion 14 is inserted into, a sliding portion 25 corresponding in position to the sliding portion 15, and a slot 26 disposed on one side of the sliding portion 25.

The movable knife 40 has a pivotal connection portion 41 pivotally disposed at the pivotal portion 14 of the body unit 1, a first pressing-swinging portion 43, a second pressing-swinging portion 44, and a cutting portion 45.

The operating unit 5 has a slide 50 and a cushioning element 60 coupled to the slide 50.

The slide 50 has a sliding portion 51 disposed at the sliding portion 15 of the body unit 1, an operating portion 52 for connecting with and driving the sliding portion 51, a positioning portion 53 positioned at each sliding-positioning portion 153 of the body unit 1, and two engaging-protruding portions 54 disposed on one sides of the sliding portion 51.

The operating portion 52 is slidable within the operating hole 17 and blocked by the operating-positioning portion 171 from two sides.

Both the operating-positioning portion 171 and the positioning portion 53 are each hollowed out on the other side, so as to be deformable and movable.

The cushioning element 60 has an engaging portion 61 which abuts against the sliding portion 51 of the slide 50, two engaging holes 62 for fitting around the engaging-protruding portions 54 of the slide 50, a knife controlling portion 63 for actuating the movable knife 40 to rotate about the pivotal portion 14 of the body unit 1 and thus allow the cutting portion 45 of the movable knife 40 to be exposed from or to retract into the access slit 16.

The knife controlling portion 63 actuates the first pressing-swinging portion 43 of the movable knife 40 to allow the cutting portion 45 of the movable knife 40 to retract into the access slit 16. The knife controlling portion 63 actuates the second pressing-swinging portion 44 of the movable knife 40 to swing and thus allow the cutting portion 45 of the movable knife 40 to be exposed from the access slit 16.

The two blades 70 are disposed in the body member 10 and each have a sharp edge 72 corresponding in position to the film feeding opening 18.

The guide member 80 is mounted on the body unit 1 and corresponds in position to the film feeding opening 18.

The cushioning element 60 not only enables the movable knife 40 to slide and press on better but also reduces the wear and tear of the slide 50 and thus renders it durable.

The first pressing-swinging portion 43 of the movable knife 40 flanks the pivotal connection portion 41 and presses against the knife controlling portion 63 of the cushioning element 60; hence, the first pressing-swinging portion 43 enables the movable knife 40 to swing and rotate steadily without vibrating.

Therefore, the film cutter of the present invention is characterized in that the movable knife 40 is not only protruded and retracted conveniently, quickly but also secured firmly, precisely. Hence, the embodiment achieves the objectives of the present invention.

In addition to the aforesaid embodiment, the present invention may be implemented according to a variant embodiment as follows:

For instance, the body unit 1 does not necessarily consist of the aforesaid two members, namely the body member 10 and the cover member 20, and thus the body unit 1 may be provided in the form of a single member.

Alternatively, the operating unit 5 does not necessarily have the cushioning element 60, and the knife controlling portion 63 is formed from the slide 50.

The aforesaid embodiments, either separately or jointly, achieve the objectives of the present invention.

In conclusion, the film cutter of the present invention is characterized in that the movable knife 40 is not only protruded and retracted conveniently, quickly but also secured firmly, precisely, thereby achieving the objectives of the present invention.

What is claimed is:

1. A film cutter, comprising:
a body unit having a gripping portion, a receiving portion, a pivotal portion, a sliding portion, an access slit, and a film feeding opening;
a movable knife having a pivotal connection portion pivotally disposed at the pivotal portion of the body unit, and a cutting portion;
an operating unit having a sliding portion disposed at the sliding portion of the body unit, an operating portion for driving the sliding portion, a knife controlling portion for actuating the movable knife to rotate about the pivotal portion of the body unit and thus allow the cutting portion of the movable knife to be exposed from or to retract into the access slit;
two blades disposed in the body unit and each having a sharp edge tilted at an angle relative to and corresponding in position to the film feeding opening; and
a guide member mounted on the body unit and corresponding in position to the film feeding opening.

2. The film cutter of claim 1, wherein the body unit has an operating hole and an operating-positioning portion formed at the operating hole, and the operating portion is slidable within the operating hole and blocked by the operating-positioning portion from two sides.

3. The film cutter of claim 2, wherein the body unit has two sliding-positioning portions, the operating unit has a positioning portion positioned at each said sliding-positioning portion of the body unit.

4. The film cutter of claim 1, wherein the body unit has two sliding-positioning portions, the operating unit has a positioning portion positioned at each said sliding-positioning portion of the body unit.

5. The film cutter of claim 1, wherein the operating unit has a slide and a cushioning element coupled to the slide, and the knife controlling portion is disposed at the cushioning element.

6. The film cutter of claim 5, wherein the slide has an engaging-protruding portion, and the cushioning element has an engaging hole for fitting around the engaging-protruding portion of the slide.

7. The film cutter of claim 6, wherein the movable knife has a first pressing-swinging portion actuated by the knife controlling portion to allow the cutting portion of the movable knife to retract into the access slit, and a second pressing-swinging portion actuated by the knife controlling portion to swing and thus allow the cutting portion of the movable knife to be exposed from the access slit.

8. The film cutter of claim 5, wherein the movable knife has a first pressing-swinging portion actuated by the knife controlling portion to allow the cutting portion of the movable knife to retract into the access slit, and a second pressing-swinging portion actuated by the knife controlling portion to swing and thus allow the cutting portion of the movable knife to be exposed from the access slit.

9. The film cutter of claim 1, wherein the movable knife has a first pressing-swinging portion actuated by the knife controlling portion to allow the cutting portion of the movable knife to retract into the access slit, and a second pressing-swinging portion actuated by the knife controlling portion to swing and thus allow the cutting portion of the movable knife to be exposed from the access slit.
